(19) United States
(12) Patent Application Publication
(10) Pub. No.: US 2007/0103842 A1
(43) Pub. Date: May 10, 2007

(54) AC Ionizer with Enhanced Ion Balance

(75) Inventors: Leslie Partridge, Davis, CA (US); Grigoriy N. Vernitskiy, San Francisco, CA (US); Peter Gefter, South San Francisco, CA (US)

Correspondence Address: URIARTE LAW, 257 RODONOVAN DRIVE, SANTA CLARA, CA, 95051, US

(73) Assignee: MKS INSTRUMENTS, INC., Wilmington, MA (US)

(21) Appl. No.: 11/556,589

(22) Filed: Nov. 3, 2006

Related U.S. Application Data
(60) Provisional application No. 60/733,418, filed on Nov. 3, 2005.

(51) Int. Cl. H05F 3/00

(52) U.S. Cl. 361/220

(57) ABSTRACT

An improved ionizer for providing an enhanced ion balance of negative and positive ions is disclosed. The ionizer may include a first ion emitter and a second ion emitter; at least one reference electrode coupled to ground; and a power supply for providing an AC voltage to the first and second ion emitter. This power supply is DC isolated from ground. In addition, the present invention includes a first rectifier coupled in series between the first ion emitter and the power supply, a second rectifier coupled in series between the second ion emitter and the power supply. The first and second rectifiers cause a DC bipolar voltage to be created from the first and second ion emitters during operation of the ionizer.

### CROSS-REFERENCE TO RELATED APPLICATIONS

This application claims the benefit of Provisional Application 60/733,418, filed Nov. 3, 2005 and entitled “Diode Balanced AC Ionization System”.

### BACKGROUND

(1) Technical Field

This invention relates to ionizers, which are designed to remove or minimize static charge accumulation from an item selected for static charge neutralization.

(2) Background Art

Ionizers remove static charge by generating ions and delivering those ions to a charged target. One type of ionizer, named “AC ionizer”, uses an AC voltage to produce ions. One type of AC ionizer that is isolated from ground can produce equal numbers of positive and negative ions and will normally appear to have a positive ion balance because negative ions have greater mobility than positive ions. These negative ions are grounded, and thus, lost at a faster rate than positive ions. Downstream from the source of the ions, the remaining ion mixture usually has more positive than negative ions.

Electrical grounds close to the ionizing sources, such as emitter tips or emitting wires, also change the ion balance. For example, a grounded object that is closer to the positive emitter than to the negative emitter will result in a negative ion because the positive ions have a shorter path to ground. Alternately, a grounded object that is closer to the negative emitter than to the positive emitter will result in a positive ion balance when measured downstream from the ionizer.

Ion balance requirements for electro-static sensitive components are important considerations when manufacturing and handling these components. Consequently, a need exists for an improved AC ionizer that provides an enhanced ion balance.

### BRIEF SUMMARY OF THE INVENTION

The present invention relates to an improved ionizer that provides an enhanced ion balance. The ionizer may include a first ion emitter and a second ion emitter; at least one reference electrode coupled to ground; and a power supply for providing an AC voltage to the first and second ion emitter. This power supply is DC isolated from ground. In addition, the present invention includes a first rectifier coupled in series between the first ion emitter and the power supply, a second rectifier coupled in series between the second ion emitter and the power supply. The first and second rectifiers cause a DC bipolar voltage to be created from the first and second ion emitters during operation of the ionizer.

### BRIEF DESCRIPTION OF THE DRAWINGS

FIG. 1 is a block diagram showing an ionizer having enhanced ion balance in accordance with one embodiment of the present invention.

FIG. 2 is a block diagram showing a power supply that is DC isolated from ground and that may be used with an ionizer having enhanced ion balance in accordance with another embodiment of the present invention.

FIG. 3 is a block diagram showing an ionizer having enhanced ion balance in accordance with yet another embodiment of the present invention.

FIG. 4 is a block diagram showing an ionizer having enhanced ion balance in accordance with another embodiment of the present invention.

### DETAILED DESCRIPTION OF THE EMBODIMENTS OF THE INVENTION

In the following detailed description, for purposes of explanation, numerous specific details are set forth to provide a thorough understanding of the various embodiments of the present invention. Those of ordinary skill in the art will realize that these various embodiments of the present invention are illustrative only and are not intended to be limiting in any way. Other embodiments of the present invention will readily suggest themselves to such skilled persons having benefit of the herein disclosure.

In addition, for clarity purposes, not all of the routine features of the embodiments described herein are shown or described. It is appreciated that in the development of any such actual implementation, numerous implementation-specific decisions must be made to achieve the developer's specific goals. These specific goals will vary from one implementation to another and from one developer to another. Moreover, it will be appreciated that such a development effort might be complex and time-consuming but would nevertheless be a routine engineering undertaking for those of ordinary skill in the art having the benefit of the herein disclosure.

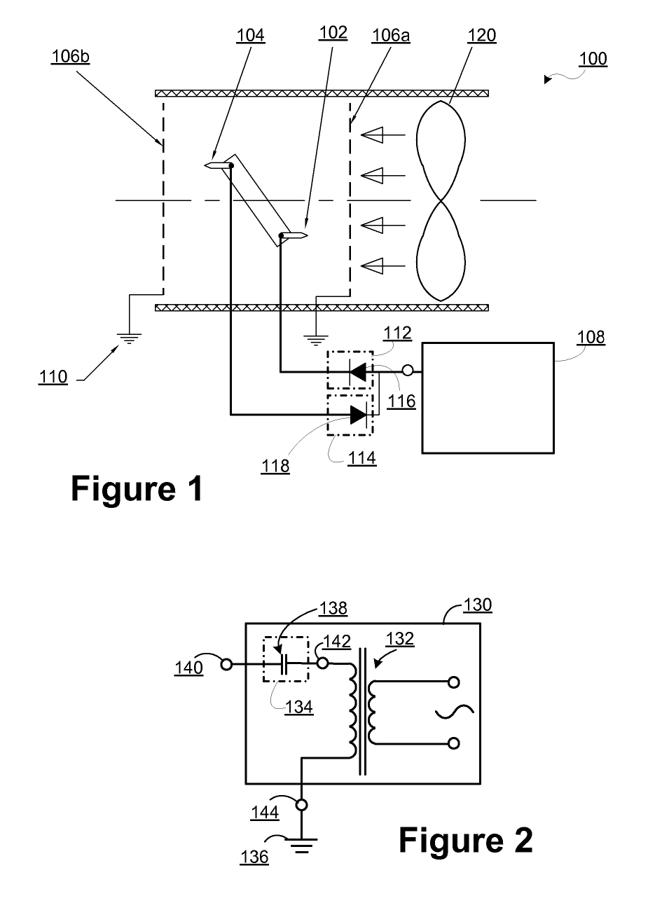

Referring now to FIG. 1, a block diagram illustration of an ionizer 100 having enhanced ion balance is shown in accordance with one embodiment of the present invention. Ionizer 100 includes a first ion emitter 102 and a second ion emitter 104; at least one reference electrode 106 coupled to ground; and a power supply 108 for providing an AC voltage to the first and second ion emitters 102 and 104. The term ion emitter is intended to include an electrode that emits ions by corona discharge upon receiving a sufficient voltage. In the embodiment shown, this AC voltage has a voltage magnitude sufficient to cause a corona discharge when the voltage is applied to an ion emitter, such as emitters 102 and 104. An ion emitter may be implemented in the form of a conductive cylinder having a sharp point at one end, a wire, a loop and the like. Ion emitters, sometimes referred to as ionizing electrodes, are commonly known by those of ordinary skill in the art.

Power supply 108 is DC isolated from a source 110 having a ground potential, named “ground” 110. The term DC isolated is defined as a configuration in which any DC component from ground 110 is electrically decoupled from power supply 108, precluding DC from flowing to power supply 108 from ground 110. The term DC is sometimes referred to as direct current.

In addition, ionizer 100 further includes a first rectifier 112 coupled in series between first ion emitter 102 and power supply 108, a second rectifier 114 coupled in series between second ion emitter 104 and power supply 108. First and second rectifiers 112 and 114 cause a bipolar voltage to be created from first and second ion emitters during operation of the ionizer. First and second rectifiers may be implemented using any device that can limit the flow of current in one direction, such as a diode, transistor, a Zener diode or their respective equivalents.

In the example shown in FIG. 1, rectifiers 112 and 114 are implemented in the form of diodes 116 and 118, respectively. Diode 116 includes a cathode coupled to first ion emitter 102 and an anode for receiving a voltage potential sourced from power supply 108, while diode 118 includes an anode coupled to second ion emitter 104 and a cathode for receiving a voltage potential sourced from power supply 108.

Ionizer 100 is also shown configured with at least one gas moving device 120 for moving gas across first and second ion emitters 102 and 104 and generally towards the selected item. The use, type, placement and structure of this device are not intended to limit the embodiment of the present invention disclosed in FIG. 1. Device 120 may be omitted if another means for moving gas across emitters 102 and 104 is provided. For example, a gas provided by a pressurized source may be used.

The balance of positive and negative ions produced by ionizer 100 may be enhanced at the point of neutralization or at a location downstream from the ion emitters 102 and 104 by selecting a DC bipolar voltage. This DC bipolar voltage may be established by placing ion emitters 102 and 104 at a selected distance from each other. A downstream ion balance of approximately zero volts may then be obtained by varying the distance between an ion emitter that generates positive ions, such as ion emitter 102, and a reference electrode that is nearby or nearest to ion emitter 102, such as reference electrode 106. For example, an enhanced ion balance that may be achieved with the example in FIG. 1 may be less than a +/−10 volt difference between negative and positive ions when measured collectively at or near an item (not shown) selected for neutralization.

FIG. 2 illustrates one example of a power supply 130 that is DC isolated from ground and that may be used to implement power supply 108 in FIG. 1. Power supply 130 includes a high voltage transformer 132 and a DC decoupling element 134. DC decoupling element may be implemented by using a device that electrically decouples power supply 130 from direct current that can flow from ground 136, precluding this direct current from flowing to power supply 130. DC decoupling element 134 may include a capacitor 138 as shown although the use of capacitor 138 is not intended to limit the scope and spirit of embodiment disclosed in FIG. 2. In FIG. 2, DC decoupling element 134 is coupled in series between power supply output 140 and high voltage terminal 142 of transformer 132. However, in an alternative embodiment, which is not shown in FIG. 2, DC decoupling element 134 may be coupled in series between ground 136 and low voltage terminal 144 of transformer 132.

In addition, implementing a power supply 130 in the manner shown is not intended to be limiting in any way. Any power supply that is DC isolated from a selected potential, such as ground, may be utilized. For example, a power supply that uses a piezo-electric AC generator provides DC isolation from ground.

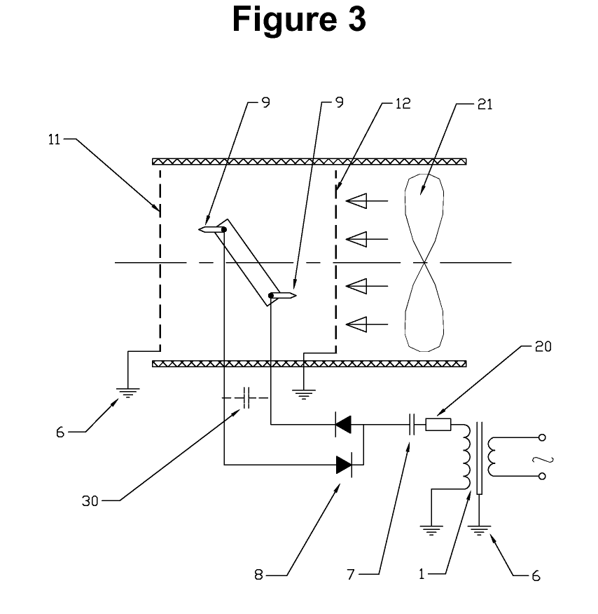

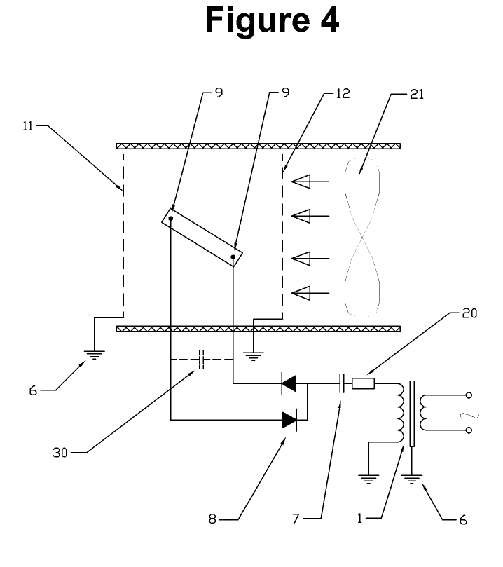

FIGS. 3 and 4 are two additional embodiments of novel ionizers with air movers 21 that have been modified with capacitors 7 and diodes 8. The ionizers also include reference electrodes 11 and 12. Inclusion of a resistor 20 in series with the capacitor 7 is useful, but not essential. The diodes 8 provide a DC bipolar voltage between the emitters 9 in addition to the AC voltage.

FIGS. 3 and 4 show that the capacitor 7 is placed between the diodes 8 and the high voltage terminal of the transformer 1. FIG. 2 and FIG. 3 also show that the low voltage terminal of the transformer is grounded.

The amplitude of the bipolar DC voltage depends upon an inherent capacitance 30 between the emitters 9. In turn, the inherent capacitance 30 between the emitters 9 depends on how close each emitter 9 is to ground 6.

By varying the distance between the positive and negative emitters 9 and their respective nearby ground(s) 6, enhanced or near zero ion balance can be obtained at the point of neutralization or at a location downstream from the emitters.

Note that the diodes 8 are necessary for the creation of a DC bipolar voltage, and are a central component of this inventive concept. In one embodiment, a positive directed diode is placed in series with a first ionizing electrode, such as a first wire or group of shafts with sharp tips, while a negative directed diode is placed in series with a second ionizing electrode, such as a second wire or group of shafts with sharp tips. A positive directed diode is defined as a diode that passes positive current, while a negative directed diode is defined as a diode that passes negative (electron) current.

In FIG. 4, wires are used for emitters 9. One wire is attached to each terminal of the transformer's 1 output. Since the view of FIG. 4 is along the length of the wires, the wires are shown as points. The wires are placed parallel to each other, and parallel to the long dimension of the ionizer. By rotating the wires along the long dimension, or by balancing the wires between two grounded items (such as blowers, heaters or metal guards), the relative position of each emitter wire to grounds is changed. Hence, one ion polarity is selectively closer to ground, and workstation balance is changed.

In FIG. 3, the emitters 9 comprise shafts with sharp tips. Multiple shafts with sharp tips are typically used. Since the view of FIG. 3 is along the length of the ionizer, only one pair of emitters is shown. One group of shafts with sharp tips is attached to each terminal of the transformer's 1 output.

The balance of this ionizer is shifted by bringing the mean distance of one group of shafts with sharp tips closer to ground than the mean distance of the second group of shafts with sharp tips. This can be accomplished by rotation, angling or translation of the emitter groups. Combined rotation, angling or translation may be appropriate.

For example, two wire emitters 9 may be used, and both wires are contained in a single plane. Ion balance is achieved by positioning the first wire closer to ground than the second wire. After positioning the emitter, the emitters may either be configured in a fixed position or movable wire attachment connectors may be used to allow each wire to be moved separately while maintaining both wires in the same plane.

In another example, two wire emitters 9 are employed, and both wires are contained in a single plane. Ion balance is achieved by rotating a mechanism which holds both wires in a parallel plane. Rotation brings one of the two wires closer to ground.

In yet another example, a group of shafts with sharp tips may be used and the shafts forms a plane. One plane is moved closer to ground 6 than the second plane to adjust balance.

Ion balance may also be achieved by holding the ion emitters stationary, and moving the reference electrodes, such as reference electrodes 11 and 12 shown in FIGS. 3 and 4.

Relative distances between emitter planes and their respective grounds are selected for optimal performance. This is true regardless of whether shafts with sharp tips are used or wires are used for emitters 9.

Optimal relative distances between components vary with the specific AC ionizer design. In one specific case, the optimal distance between the first emitter plane and ground is more than 4 times the distance between the second emitter plane and ground. In a second specific case, the optimal distance between the first emitter plane and ground is 2 to 4 times the distance between the second emitter plane and ground. In a third specific case, the optimal distance between the first emitter plane and ground is 1.2 to 2 times the distance between the second emitter plane and ground.

The distance between emitter planes can also be optimized. In an operating prototype, the distance from the first emitter plane to ground is 0.5 to 5 times the distance between the first and second emitter planes. And the distance from the second emitter plane to ground is 3 to 8 times the distance between the first and second emitter planes. In this prototype, the first emitter plane is in series with the positive directed diode, and the second emitter plane is in series with the negative directed diode.

When wires are used for emitters in the prototype, the distance between wires is approximately between an eight of inch (⅛) and three (3) inches and achieves an enhanced or near zero ion balance of at least less than +/−10 volts.

Emitters 9 may be placed upwind or downwind from the air mover 21. Since air must flow through the grounded reference electrodes 11 and 12. Reference electrodes 11 and 12 may be configured to have porosity greater than 70%, where porosity is defined as the ratio of open area to the total area of reference electrodes 11 and 12. Reference electrodes 11 and 12 may have varying shapes and sizes.

While the present invention has been described in particular embodiments, it should be appreciated that the present invention should not be construed as limited by such embodiments. Rather, the present invention should be construed according to the claims below.

We claim:

1. An ionizer for removing static charge from a selected item by using air ions, said ionizer comprising:
a first ion emitter;
a second ion emitter positioned at a different physical location from said first ion emitter;
at least one reference electrode coupled to ground;
a power supply for providing an AC voltage to said first and second ion emitter, said power supply DC isolated from said ground;
a first rectifier coupled in series between said first ion emitter and said power supply;
a second rectifier coupled in series between said second ion emitter and said power supply; and
wherein said first and second rectifiers cause a DC bipolar voltage to be present at said first and second ion emitters during operation of the ionizer.

2. The ionizer of claim 1, wherein said power supply includes:
a high voltage transformer; and
a DC decoupling element.

3. The ionizer of claim 2, wherein said DC decoupling element includes a capacitor.

4. The ionizer of claim 1, wherein said power supply includes a piezo-electric element.

5. The ionizer of claim 1, wherein said power supply includes a high voltage transformer coupled to ground, to said first and second ion emitters; and to a capacitor.

6. The ionizer of claim 1, wherein said power supply includes a high voltage transformer coupled to a capacitor.

7. The ionizer of claim 1, wherein:
said first rectifier includes a diode having cathode coupled to said first ion emitter and an anode for receiving a voltage potential sourced from said power supply; and
said second rectifier includes a diode having an anode coupled to said second ion emitter and a cathode for receiving a voltage potential sourced from said power supply.

8. The ionizer of claim 1, further including at least one gas moving device for moving gas across said first and second ion emitter and generally towards the selected item.

9. The ionizer of claim 1, wherein a first distance between said first ionizing electrode and one of said at least one reference electrode, said first distance different from a second distance between said second ionizing electrode and one of said at least one reference electrode.

10. The ionizer of claim 1, wherein said first rectifier includes any one of a diode, a transistor and a Zener diode.

11. An ionizer for removing static charge from a target using air ions, comprising:
one or more first ionizing electrodes;
one or more second ionizing electrodes positioned at a different physical location from said first ionizing electrodes;
one or more reference electrodes;
at least one high voltage transformer with one terminal of said high voltage transformer coupled with a capacitor;
and at least one air moving apparatus;
one or more positive directed diodes connected in series with said first ionizing electrodes;
one or more negative directed diodes connected in series with said second ionizing electrodes; and
a distance between said first ionizing electrode and the nearest reference electrode to said first ionizing electrode which is different from the distance between said second ionizing electrode and the nearest reference electrode to said second ionizing electrode.

12. The ionizer in claim 11, in which a positive directed diode(s) is placed between said capacitor and said first ionizing electrode(s), and a negative directed diode(s) is placed between said capacitor and a said second ionizing electrode(s). The ionizer in claim 1, wherein a positive directed diode is placed between said capacitor and said first ionizing electrode(s), and a negative directed diode(s) is placed between said capacitor and a said second ionizing electrode(s).

13. The ionizer in claim 12 where the distance from said second ionizing electrode to its closest reference electrode is more than 4 times larger than the distance from said first ionizing electrodes to its closest reference electrode.

14. The ionizer in claim 12 where the distance from said second ionizing electrodes to its closest reference electrode is 2 to 4 times larger than the distance from said first ionizing electrodes to its closest reference electrode.

15. The ionizer in claim 12 where the distance from said second ionizing electrodes to its closest reference electrode is 1.2 to 2 times larger than the distance from said first ionizing electrodes to its closest reference electrode.

16. The ionizer in claim 12 where the distance between said first ionizing electrode and its nearest reference electrode is 0.5 to 5 times larger than the distance between said first ionizing electrode and said second ionizing electrode.

17. The ionizer in claim 12 where the distance between said second ionizing electrode and its nearest reference electrode is three to eight times larger than the distance between said first ionizing electrode and said second ionizing electrode.

18. The ionizer in claim 11 in which said first ionizing electrodes and said second ionizing electrodes comprise wires or filaments.

19. The ionizer in claim 18 where said wires or filaments are disposed as parallel lines within a first plane.

20. The ionizer in claim 19 where said wires or filaments are more than ⅛ inch apart.

21. The ionizer in claim 19 where said wires or filaments are less than 3 inches apart.

22. The ionizer in claim 11 in which said first ionizing electrodes and said second ionizing electrodes comprise tapered corona electrodes, and air ions are produced at the low radius end.

23. The ionizer in claim 22 in which said low radius ends of said first ionizing electrodes are disposed in a second plane.

24. The ionizer in claim 23 in which said low radius ends of said second ionizing electrodes are disposed in a third plane.

25. The ionizer in claim 24 where said second plane and second third plane are parallel.

26. The ionizer in claim 25 where said second plane and second third plane are more than ⅛ inch apart.

27. The ionizer in claim 25 where said second plane and second third plane are less than 3 inches apart.

28. The ionizer in claim 11 in which said ionizing electrodes are positioned between two said reference electrodes.

29. The ionizer in claim 11 in which said capacitor is positioned between said diodes and the high voltage terminal of said high voltage transformer.

30. The ionizer in claim 11 where the low voltage terminal of said high voltage transformer is grounded.

31. The ionizer in claim 11 in which said capacitor is positioned between said high voltage transformer and said first ionizing electrodes.

32. The ionizer in claim 11 in which said capacitor is positioned between said high voltage transformer and said second ionizing electrodes.

33. The ionizer in claim 11 in which said first ionizing electrodes and said second ionizing electrodes can be positioned or repositioned to change the distances to said reference electrodes.

34. The ionizer in claim 33 which further includes a mechanism to reposition said first ionizing electrodes or said second ionizing electrodes or said reference electrodes.

35. The ionizer in claim 11 in which a resistor is placed anywhere between said high voltage transformer and either said first ionizing electrodes or said second ionizing electrodes.

36. The ionizer in claim 11 in which a resistor is placed between any said ionizing electrodes and any said diodes.

37. The ionizer in claim 11 in which the reference electrodes have an area porosity of 70% or greater in the direction of air flow.

38. The ionizer in claim 11 in which different reference electrodes have the same or different dimensions.

39. The ionizer in claim 11 in which one or more said reference electrodes are positioned downwind of said air moving apparatus.

40. A method of providing an ionizer having a balanced ion output, the method comprising:
providing a first ion emitter;
providing a second ion emitter;
providing at least one reference electrode coupled to ground;
providing a power supply for providing an AC voltage to said first and second ion emitter, said power supply DC isolated from said ground;
providing a first rectifier coupled in series between said first ion emitter and said power supply;
providing a second rectifier coupled in series between said second ion emitter and said power supply; and
wherein said first and second rectifiers cause a DC bipolar voltage to be present at said first and second ion emitters during operation of the ionizer.

41. The method of claim 40, further including:
selecting a DC bipolar voltage amount at said first and second ion emitters during operation of the ionizer; and
varying the distance between said first ion emitter and a reference electrode that is nearest to said first ion emitter.

42. The method of claim 41, wherein said selecting includes varying the distance between said first and second ion emitters until said DC bipolar voltage amount is obtained.
